(19) United States
(12) Patent Application Publication
(10) Pub. No.: US 2026/0065320 A1
(43) Pub. Date: Mar. 5, 2026

(54) SYSTEM AND METHOD OF PROVIDING PRODUCT INFORMATION USING AI VOICE

(71) Applicant: THE DELICIOUS HARU CO., LTD., Gyeonggi-do (KR)

(72) Inventor: JIN HO PARK, Gyeonggi-do (KR)

(21) Appl. No.: 19/309,869

(22) Filed: Aug. 26, 2025

(30) Foreign Application Priority Data
Aug. 30, 2024 (KR) 10-2024-0118157

(51) Int. Cl. G06Q 30/0251; G06F 40/58

(52) U.S. Cl. CPC G06Q 30/0255; G06F 40/58; G06Q 30/0267

(57) ABSTRACT

A method for providing product information includes determining a consumer related to promotional product information in a seller server, providing the promotional product information to the determined consumer's device by voice, and providing response information according to the additional information request to the consumer's device when receiving an additional information request from the consumer's device, wherein the promotional product information provided by voice is set to be displayed together with a voice output in the consumer's device.

### CROSS-REFERENCE TO RELATED APPLICATION AND CLAIM OF PRIORITY

This application claims the benefit under 35 USC § 119 of Korean Patent Application No. 10-2024-0118157, filed on Aug. 30, 2024, in the Korean Intellectual Property Office, the entire disclosure of which is incorporated herein by reference for all purposes.

### BACKGROUND

### 1. Technical Field

The present invention relates to a method and system for providing product information using AI voice, and more specifically, to a method and system for providing suitable product information to consumers using AI voice.

### 2. Background Art

Recently, with the widespread adoption of Artificial Intelligence (AI) services like ChatGPT, AI services are being utilized in various commercial activities.

While traditional AI services were limited to simple tasks such as recommending repurchases of existing products or new products of the same type, recent research is actively underway to analyze consumers' current interests, predict their interests, and provide product information accordingly.

In particular, AI modules are being utilized as a means of providing product information in various fields, such as analyzing content viewed by consumers and providing purchase services for related products (Korean Patent Publication No. 10-2019-0092887) or using AI modules to provide financial consulting services (Korean Patent Publication No. 10-2022-0006848).

### SUMMARY

The present invention aims to address the problems of the prior art described above, and can provide consumers with suitable product information.

According to the present invention, information requested by consumers can be provided in real time via voice.

One embodiment of the present invention relates to a method for providing product information. The method comprises the steps of: determining a consumer related with promotional product information from a seller server; providing the promotional product information to the determined consumer's device; and, when receiving a request for additional information from the consumer's device, providing response information to the consumer's device in response to the request for additional information. The provided promotional product information is characterized in that it is set to be displayed along with voice output on the consumer's device.

Furthermore, the step of determining the consumer is characterized in that the consumer is determined based on purchase history information of products associated with the promotional product.

Furthermore, the step of providing the promotional product information is characterized in that the promotional product information is provided in the selected consumer's preferred language. If the consumer speaks multiple languages, the promotional product information translated into the multiple languages is provided as a voice.

Furthermore, the method comprises performing an authentication process with the determined consumer before providing the promotional product information.

Furthermore, the promotional product information is meat product information, comprising the type of meat, market price information, and purchase limit information.

Another embodiment of the present invention relates to a product information provision system, comprising: a seller server; and a consumer's device. The seller server comprises: a product management unit that determines a promotional product; a consumer information management unit that determines a consumer related with the promotional product information; and a voice service unit that provides the promotional product information to the determined consumer's device via voice and, when receiving a request for additional information from the consumer's device, provides response information to the consumer's device in response to the request. The consumer's device is configured to display the promotional product information along with voice output.

Furthermore, the consumer information management unit determines the consumer based on purchase history information of products associated with the promotional product.

Furthermore, the voice service unit provides the promotional product information via voice in a language set by the consumer. If the consumer speaks multiple languages, the voice service unit provides the promotional product information translated into the multiple languages.

Furthermore, the consumer information management unit is configured to perform an authentication process with the determined consumer before providing the promotional product information via voice.

Furthermore, the promotional product information is meat product information, comprising the type of meat, market price information, and purchase limit information.

The present invention aims to address the problems of the prior art described above, and can provide consumers with suitable product information.

According to the present invention, information requested by consumers can be provided in real time via voice.

### BRIEF DESCRIPTION OF THE DRAWINGS

FIG. 1 is a conceptual diagram illustrating a product information provision system according to an example of the present invention.

FIG. 2 is a flowchart illustrating a product information provision process according to an example of the present invention.

FIG. 3 is a diagram illustrating consumer authentication according to an example of the present invention.

FIG. 4 is a diagram illustrating promotional product information provision according to an example of the present invention.

FIG. 5 is a diagram illustrating promotional product information provision using multiple languages according to an example of the present invention.

FIG. 6 is a block diagram conceptually illustrating the structure of a product information provision server according to an example of the present invention.

### DETAILED DESCRIPTION

Hereinafter, with reference to the attached drawings, embodiments of the present invention are described in detail so that those skilled in the art can easily practice the present invention. However, the present invention may be implemented in various different forms and is not limited to the embodiments described herein. In addition, in the drawings, parts unrelated to the description are omitted to clearly explain the present invention, and similar parts are designated with similar drawing reference numerals throughout the specification.

Throughout the specification, when a part is said to be “connected” to another part, this includes not only the cases where they are “directly connected” but also the cases where they are “electrically connected” with other elements in between. Furthermore, when a part is said to “comprise” a component, this does not mean that the other components are excluded, but rather that the other components can be included, unless otherwise specifically stated.

In the present invention, “promotional product” refers to a product offered by a seller at a discounted price to promote sales.

While the present invention focuses on meat, it is not necessarily limited thereto. Due to the nature of meat, its price fluctuates depending on factors such as the sales period and quantity, making it different from industrial products.

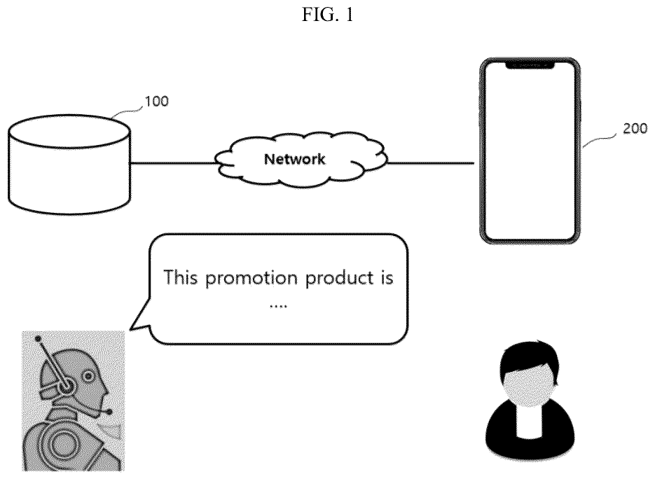

FIG. 1 is a conceptual diagram illustrating a product information provision system according to an example of the present invention.

As illustrated in FIG. 1, a product information provision system according to an example of the present invention comprises a server (100) and a consumer's device (200) connected via a network.

The server (100) according to an example of the present invention is a device that collects or generates information of interest to consumers and provides it to the consumer's device. While described herein as a server, any device capable of performing the above functions, such as a server, desktop, Mac, laptop, smartphone, or tablet PC, is sufficient.

The consumer's device (200) according to an example of the present invention is a device used by a consumer purchasing a product. Any device capable of receiving and confirming product information provided by the server (100), such as a smartphone, tablet PC, desktop, Mac, laptop, smartwatch, smartglass, smartband, or smartring, is sufficient.

A server (100) according to an example of the present invention may convert product information into voice and provide it to a consumer's device (200), or may provide character information such as text to the consumer's device (200) so that it can be output as voice from the consumer's device (200).

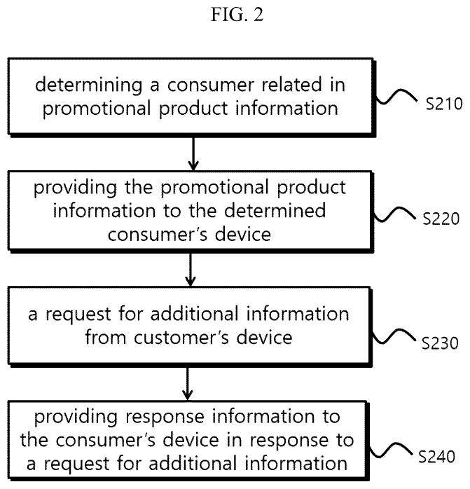

FIG. 2 is a flowchart illustrating a product information provision process according to an example of the present invention.

According to an example of the present invention, a server determines consumers related with promotional product information (S210).

According to an example of the present invention, a server can save and manage information on multiple consumers in a database. For example, it can accumulate and manage information such as past purchases, names, addresses, contact information, and products of interest by creating a database.

According to an example of the present invention, a server can save product information on a seller, and the seller may be a seller handling meat. Meat encompasses various product categories, such as beef, pork, and chicken. Specifically, product information can be organized into a hierarchical database using various classification criteria, such as meat variety or cut, and managed along with information such as purchase cost, distribution costs (storage and transportation costs), and desired selling price.

According to an example of the present invention, a server generates promotional product information. Promotional product information provides discounts or benefits for specific products. For example, a 10 kg chicken product priced at 30,000 won can be sold for 10,000 won, or a coupon can be provided for future purchases with the purchase of 10 kg of chicken.

A server according to an example of the present invention can automatically generate promotional product information. The server can learn information about meat products imported, distributed, and produced by the seller, as well as expiration dates, storage quantities, and past sales history, to automatically generate promotional product information predicted to be purchased above a certain level.

For example, if the amount of imported beef in a seller's inventory exceeds an allowable amount and additional imported beef is soon to be stored, the server according to an example of the present invention can determine the selling price of the imported beef based on past similar inventory levels and sales information.

As another example, the server according to an example of the present invention can determine the selling price based on consumption during periods when sales are expected to proceed smoothly, such as holidays or the end of the year.

Unlike domestically produced meat, which is raised, slaughtered, and provided domestically, imported meat is difficult to predict for distribution volume and sales price after a considerable period of time, including shipping. Therefore, storage capacity and distribution margins can be key factors in determining sales prices.

According to an example of the present invention, a server can determine promotional products based on recent consumer trend information collected. For example, if “Iberico” is frequently featured in the media, and the frequency of online keyword exposure for “Iberico” exceeds a preset level, the server can determine Iberico products as promotional products.

This method of determining promotional products has the advantageous effect of allowing sellers to sell trend-aligned products in a timely manner.

According to an example of the present invention, a server can utilize various methods to determine consumers related with promotional products. The first method is to determine consumers based on past purchase history.

A server according to an example of the present invention can save and manage existing purchase histories information. For example, server may store the information that consumer A runs a fried chicken restaurant in Seoul, primarily purchases Brazilian chicken every two weeks, and purchases 100 kg per purchase.

A second method involves collecting consumer information from affiliate servers and attracting new consumers. For example, a server according to an example of the present invention may collect information from a franchise headquarters regarding the opening of a restaurant by consumer B and determine consumer B as a new customer.

A third method involves consumers who have registered products of interest with a seller server. For example, consumer C may have registered American and Chilean pork as products of interest with the seller server to check market prices.

A server according to an example of the present invention can generate personalized promotional product information for each consumer, as each consumer has different purchasing abilities and purchase types. This can provide meaningful information to each consumer.

A server according to an embodiment of the present invention may provide promotional product information to a determined consumer's device in the form of voice, text, or video content.

A server according to an embodiment of the present invention may convert promotional product information into voice using Text-to-Speech (TTS) technology and transmit the converted voice information to the consumer's device.

A telephone call may be used to transmit voice information to the consumer's device, and the voice information may be provided by connecting a call to the consumer's mobile phone number.

A server according to an embodiment of the present invention may provide promotional product information to the consumer's device in the form of text or video content, allowing the information to be output as voice, text, or video on the consumer's device. For this purpose, the output format may be preset on the consumer's device.

A consumer according to an embodiment of the present invention, interested in promotional product information, may request additional information about the promotional product from the server via the consumer's device (S230).

According to an example of the present invention, a server receives a request for additional information from a consumer's device, generates response information thereto, and provides the response information to the consumer's device (S240).

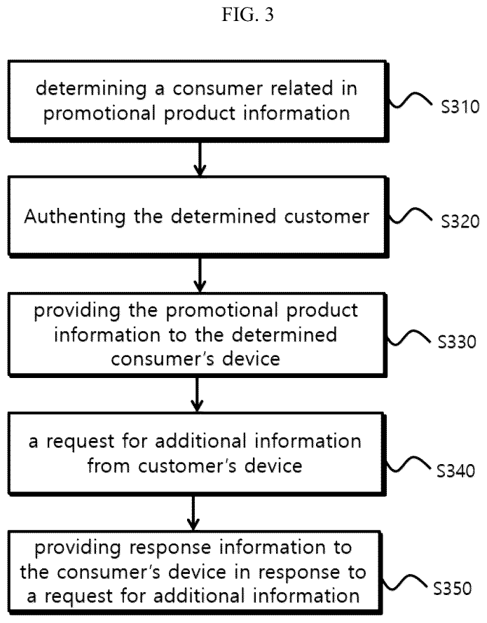

FIG. 3 is a diagram illustrating consumer authentication according to an example of the present invention.

As illustrated in FIG. 3, in step S320, a server according to an embodiment of the present invention may perform a consumer authentication process prior to providing promotional product information to the determined consumer's device.

Promotional information according to an embodiment of the present invention is personalized for each consumer. Rather than providing the same promotion to all consumers, it may provide different promotions to each customer based on factors such as their purchasing history, purchasing ability, and new customer acquisition. Therefore, more accurate promotional product information can be provided through the consumer authentication process.

For example, a seller server may collect information that Consumer B, who is expected to purchase 10 kg of Brazilian chicken as a promotional product, has opened a restaurant. The seller may then contact Consumer B using the collected contact information to verify that Consumer B is the consumer.

According to an embodiment of the present invention, various methods for authenticating consumers on the server may be used. Authentication may be performed using biometric information such as the consumer's iris, face, blood vessel, or voice, or using an identification code (e.g., customer number) preset on the server.

According to one example of the present invention, identifying consumers can be an efficient way to provide personalized promotional product information. For example, the promotional product information considered important to each consumer may vary. For example, the server may provide promotional product information focused on selling price to Consumer C, with selling price being the most important variable.

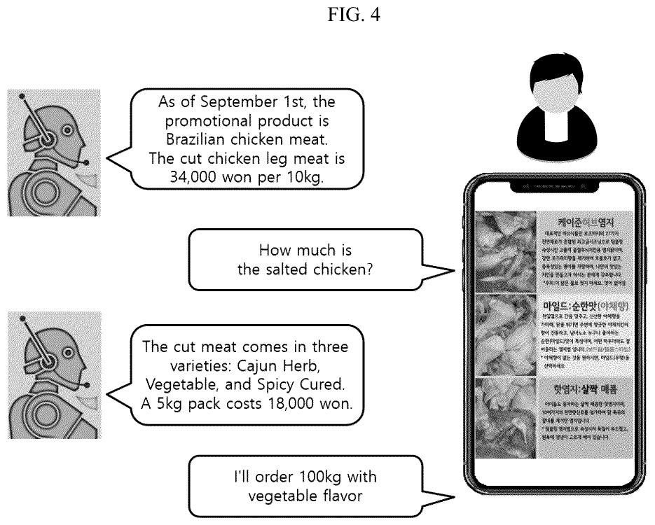

FIG. 4 is a diagram illustrating promotional product information provision according to an example of the present invention.

As illustrated in FIG. 4, the provision of promotional product information according to an example of the present invention can be performed interactively.

The consumer's device can request additional information regarding the promotional product information provided by the server, and response information can be generated and provided to the consumer's device in response to the additional information request.

The server according to an example of the present invention can provide promotional product information and additional information in a visual display on the consumer's device, and the information can be displayed on the consumer's device so that the consumer can view it along with audio information.

The server according to an example of the present invention can process consumer order information regarding promotional product information.

When the server according to an example of the present invention receives consumer order information regarding promotional product information through the consumer's device, it can process the information based on the consumer's order information and past purchase history. For example, if the current promotional product is different from a previously purchased product, the server can request re-confirmation from the consumer's device.

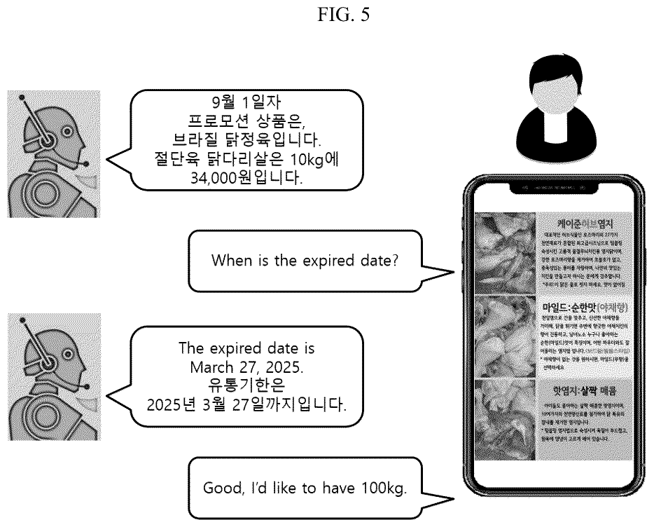

FIG. 5 is a diagram illustrating promotional product information provision using multiple languages according to an example of the present invention.

As illustrated in FIG. 5, a server according to an example of the present invention can provide a voice-based interactive service with a consumer's device.

The server according to an example of the present invention, as an advanced voice recognition service, can recognize multiple languages, including various accents and intonations. Consumers in the present invention may reside domestically or internationally, and may not necessarily use Korean, but may use various languages such as English, Spanish, Chinese, and Thai.

Therefore, the server according to an example of the present invention can identify the language information used by the consumer and determine the correct language by analyzing the type of words used, intonation, etc. For example, even in English-speaking countries, words referring to the same product (e.g., sirloin) may differ (e.g., loin vs. sirloin), and the location of the accent in the voice can also be used to determine the consumer's residential region.

According to one embodiment of the present invention, a server can provide promotional product information in a language used by a consumer based on that language. Consumers can feel a sense of familiarity and accurately recognize information through an AI voice service that uses the same or similar language.

According to one embodiment of the present invention, if a consumer speaks multiple languages, the server can provide the promotional product information translated into multiple languages through voice. In some cases, the consumer may conduct a voice conversation with the server using multiple languages rather than a single language. In such cases, promotional product information can be generated and provided in each of the multiple languages.

The present invention is not limited to providing promotional product information within South Korea, but rather relates to a method applicable globally. Therefore, the technology can be applied to countries with diverse languages (e.g., Canada, Singapore).

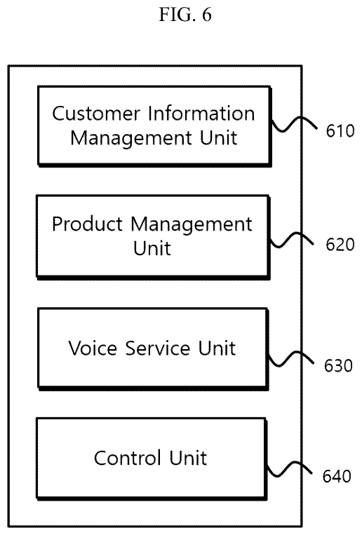

FIG. 6 is a block diagram conceptually illustrating the structure of a product information provision server according to an example of the present invention.

As illustrated in FIG. 6, a server (600) according to an embodiment of the present invention includes a consumer information management unit (610), a product management unit (620), a voice service unit (630), and a control unit (640). Although not shown in the present invention, additional components, such as an input/output unit, a power supply unit, a storage unit, a communication unit, and a display unit, may be included to ensure smooth operation of the server.

The consumer information management unit (610) according to an embodiment of the present invention manages consumer information based on the purchase history of products related to the promotional product, etc., to determine consumers to whom promotional product information will be sent.

The consumer information management unit (610) according to an embodiment of the present invention can save and manage consumer information collected through partnerships, as well as existing consumers, in a database to attract new consumers. For example, franchise owner information received through a partnership with a franchise headquarters can be collected and used to determine consumers eligible for promotions.

According to an example of the present invention, the consumer information management unit (610) can determine consumers based on consumer information registered in the server for products of interest, even without a purchase history.

According to an example of the present invention, the product management unit (620) determines promotional products to be provided to consumer's device.

The promotional products in the present invention may vary for each consumer and represent a different level of promotional product information than conventional, consistent promotions. Therefore, the product management unit (620) according to an example of the present invention can analyze the purchase history and tendencies of the determined consumer to determine customized promotional products.

For example, for a consumer identified as frequently purchasing new products whenever a chicken brine is changed, promotional product information can be provided focusing on new products.

Furthermore, the product management unit (620) according to an example of the present invention can be configured to perform an authentication process with the determined consumer before providing promotional product information via voice.

According to an example of the present invention, the product management unit (620) processes purchase order information for promotional products and general products when receiving it from a consumer's device. If the purchase order information for the promotional product differs from the existing purchase history, the unit may request the consumer's device to reconfirm the purchase order information.

According to an example of the present invention, the voice service unit (630) provides promotional product information to the determined consumer's device, and if a request for additional information is received from the consumer's device, it provides response information corresponding to the request for additional information to the consumer's device.

According to an example of the present invention, the voice service unit (630) provides promotional product information in a voice format in the consumer's preferred language. If the consumer speaks multiple languages, the voice service unit may provide the promotional product information translated into multiple languages.

One embodiment of the present invention may also be implemented in the form of a recording medium containing computer-executable instructions, such as program modules, executed by a computer. Computer-readable media may be any available media that can be accessed by a computer, and includes both volatile and nonvolatile media, removable and non-removable media. Furthermore, computer-readable media may include both computer storage media and communication media. Computer storage media includes both volatile and nonvolatile, removable and non-removable media implemented in any method or technology for storing information, such as computer-readable instructions, data structures, program modules, or other data. Communication media typically includes computer-readable instructions, data structures, program modules, or other data in a modulated data signal, such as a carrier wave, or other transport mechanism, and includes any information delivery media.

While the methods and systems of the present invention have been described with respect to specific embodiments, some or all of their components or operations may be implemented using a computer system having a general-purpose hardware architecture.

The above description of the present invention is provided for illustrative purposes only, and those skilled in the art will readily appreciate that modifications to other specific forms can be made without altering the technical spirit or essential characteristics of the present invention. Therefore, the embodiments described above should be understood as illustrative in all respects and not restrictive. For example, each component described as a single entity may be implemented in a distributed manner, and similarly, components described as distributed may be implemented in a combined manner.

The scope of the present invention is defined by the following claims rather than the detailed description above, and all changes or modifications derived from the meaning and scope of the claims and their equivalents should be construed as being included within the scope of the present invention.

What is claimed is:

1. A method for providing commercial product information, the method comprising:
determining a consumer related in promotional product information from seller server;
providing the promotional product information to the determined consumer's device; and
providing response information to the consumer's device in response to a request for additional information when receiving the request,
wherein the provided promotional product information is configured to be displayed along with voice output on the consumer's device.

2. The method of claim 1, wherein the determining of the consumer comprises determining the consumer based on purchase history information of products related to the promotional product.

3. The method of claim 1, wherein the providing of the promotional product information includes providing the promotional product information in the consumer's language of choice, and, if the consumer speaks multiple languages, providing the promotional product information translated into the multiple languages through voice.

4. The method of claim 1, wherein, prior to providing the promotional product information, an authentication process is performed with the determined consumer.

5. The method of claim 1, wherein the promotional product information comprises meat product information, including meat type, market price, and purchase limit information.

6. A product information providing system comprising,
a consumer's device; and
a seller server comprising:
a product management unit configured to determine a promotional product;
a consumer information management unit configured to determine a consumer related with the promotional product information; and
a voice service unit configured to:
provide the promotional product information to the determined consumer's device; and,
when receiving a request for additional information from the consumer's device, provide response information to the consumer's device in response to the request,
wherein the consumer's device is configured to display the promotional product information along with a voice output.

7. The method of claim 6, wherein the consumer information management unit is configured to determine consumers based on purchase history information for products related to the promotional product.

8. The method of claim 6, wherein the voice service unit is configured to provide promotional product information in a voice-based manner in the consumer's preferred language, and, if the consumer speaks multiple languages, is configured to provide promotional product information translated into the multiple languages. A product information provision system.

9. The method of claim 6, wherein the consumer information management unit is configured to perform an authentication process with the determined consumer before providing the promotional product information via voice.

10. The method of claim 6, wherein the promotional product information includes meat product information, comprising meat type, market price, and purchase limit information.
